(19) United States
(12) Patent Application Publication
(10) Pub. No.: US 2006/0017626 A1
(43) Pub. Date: Jan. 26, 2006

(54) Antenna module for mobile phone

(76) Inventors: Anand Kannan, Irving, TX (US); Tejas Bhatt, Irving, TX (US)

Correspondence Address: Stephen J. Wyse;Scheef & Stone L.L.P., Suite 1400, 5956 Sherry Lane, Dallas, TX, 75225, US

(21) Appl. No.: 10/890,303

(22) Filed: Jul. 12, 2004

(51) Int. Cl. H01Q 1/24

(52) U.S. Cl. 343/702

(57) ABSTRACT

An antenna module for use with a mobile telecommunication device such as a mobile phone. The antenna module includes an antenna element and, preferably, an RF (radio frequency) chain having receive circuitry and perhaps an analog-to-digital converter or other electrical components. Transmit circuitry may be present as well. The antenna module has a housing, in one or more parts, for supporting these components, and a jack through which power and data links can be formed. The jack may provide a means for adjusting the antenna so that its orientation relative to the mobile phone antenna may be altered.

### FIELD OF THE INVENTION

The present invention relates generally to radio telephony, and more specifically to an external antenna module for a wireless mobile station that may be used to increase receive diversity on the downlink of a CDMA or W-CDMA wireless communication system.

### BACKGROUND OF THE INVENTION

More and more people are using mobile telephones. A telephone is a device that converts sounds, such as a caller's voice, into electrical signals that can be transmitted to another telephone. The receiving telephone detects the transmitted signals and converts them back into sounds that another caller may hear. Typically, each of the telephones involved can both transmit and receive so that the callers may carry on a conversation. Traditional telephones are connected to a telephone network by a wire or cable through which the electrical signals are sent. The telephone network, generally speaking, is a system of interconnected wires and switches that create a transmission circuit from the calling party to the called party. The mobility of a traditional telephone is limited by the wire connecting it to the network.

A mobile phone is basically a portable radiotelephone that communicates with a telephone network using radio-frequency electromagnetic waves to communicate with a network though which call can be routed from source to destination. (The call may or may not be targeted to another mobile phone.) The advantages of a wireless communication system are apparent. Users may take their phones anywhere and use them to make calls, provided there is an appropriate receiving device within range. In many cases, they are even relatively free to move about while actively engaging in a conversation, the network being able to adjust so that the conversation may proceed uninterrupted.

Telephone networks used by mobile phones are similar but not the same as those used by traditional wire-line telephones. As background for application of the antenna module of the present invention, with reference to FIG. 1, a typical mobile network will now be briefly described. FIG. 1 is a simplified block diagram illustrating the interrelationship of selected components of a typical wireless communication network 100. Mobile phones 101, 102, and 103 are located in the network's coverage area, that is, they are within radio communication range of at least one network device. In FIG. 1, mobile phone 101 is in communication with base station 111 over air interface 121. The air interface 121 includes one or more radio channels through which the two devices exchange the electrical signals carrying a voice conversation or other information. The communication in the direction of the mobile phone is frequently called the downlink, as opposed to the communications from the mobile phone to the base station or the network device, which are referred to as the uplink. In like fashion, mobile phones 102 and 103 are communicating with base station 112 over air interfaces 122 and 123, respectively. A third base station 113 is not in FIG. 1 in active communication with any mobile device.

Although only three mobile phones are shown in FIG. 1 there will typically be many more mobile phones accessing the network at any one time. By the same token, a network will include many more base stations distributed across (and defining) the network coverage area. The base stations of a network are spread out geographically in order for mobile stations to be able to communicate with base stations that nearby. As should be apparent, short range radio communication requires less power and, generally speaking, the lower transmission-power requirements mean that there is less risk of interference even where many mobile phone transmissions are in progress. The area defined by a base station's regular communication area is often called a “cell”, giving rise to the popular terms “cellular network” and “cell phone”. Note that in FIG. 1, each of the mobile phones appears to be communicating with the base station that is geographically nearest to it, but it is not necessary that it does so. Of course, a base station must be within radio communication range, but normally there will be several base stations meeting this requirement, and a given mobile phone may use one that is more distant if the local transmission environment requires. Environmental factors affecting the pairing of a base station to a mobile phone may include the level of traffic, with one base station communicating with a maximum number of mobiles, and may also include natural or man-made obstacles interfering with normal transmission.

In addition, as a mobile phone relocates from one geographic area (cell) to another, it may change from communicating through one base station to another one that becomes more suitable utilizing a procedure called handoff (or handover). During a typical handoff procedure, the mobile and two (or more) base stations exchange appropriate control signals so that the transfer may be made with as little inconvenience to the callers as possible. In some systems, simultaneous communication with multiple base stations is used to prevent any noticeable interruption in the conversation.

As this implies, the devices participating in a wireless communication monitor the quality of calls in progress (and other signals) to determine when handoff is appropriate. Quality monitoring may also be used to ensure that a certain level of service (often called “quality of service” or “QoS”) is being maintained. Where a poor-quality transmission results in the complete loss of transmitted information, error checking and correction algorithms are applied so that the transmitting station can be notified and the lost portions can be re-transmitted.

Different QoSs may apply to different kinds of communication sessions. For example, although voice calls have been discussed thus far, wireless networks are increasingly being used for data communication as well so that mobile-phone users can access Internet-based resources, send graphical images, and simply exchange text files. In general, voice calls can tolerate much more error than data transmissions, but they take place in “real time” and therefore do not tolerate interruptions as easily. Data, on the other hand, may arrive divided into packets that can be properly reassembled regardless of their order of arrival—but the information in each packet must be determined with a high degree of accuracy. Some modern applications involve “streaming” audio and video, which is in one sense data that will be used to create a presentation for the user almost as soon as it arrives. In each case, different QoS standards may apply. (Note that while flawless transmission may be the goal, achieving it often comes at great expense, and accepting a lower QoS when it is appropriate to do so may help to conserve system resources.)

Returning to FIG. 1, each base station is connected to a mobile switching center (MSC), which will in turn provide a connection to the rest of the network. Here, base station 111 is shown connected to MSC 120, and base stations 112 and 113 communicate via MSC 125. MSCs are normally associated with a visitor location register (not shown) that stores information about the mobile phones operating within its area. MSCs, as their name implies, act as switches to route calls to their appropriate destination. A call from mobile phone 101 to mobile phone 102 might, for example, be routed through MSC 120 and MSC 125. Again, there will normally be a number of mobile switching centers in a network, and calls that are not easily handled by two adjacent MSCs will be routed through higher network levels in hierarchical fashion. MSCs are in the network of FIG. 1 connected also to gateway MSC 130, which connects this portion of the wireless network to a voice network such as the traditional telephone network (often called a public switched telephone network (PST). In similar fashion, gateway MSC 135 connects the wireless network to a data communication network such as the Internet. (In some networks, other components (not shown) may be present to handle the transmission of data.)

The cellular network architecture described above has enabled the widespread use of mobile telephones. As previously mentioned, the mobile phones communicating with nearby base stations are required to use far less transmission power than if they were communicating through a distant central antenna. The same, of course, is true of the base-station transmissions as well. (Note that the base stations and other network-infrastructure components are generally, though not necessarily, in communication by some other means than radio-frequency transmission.) The radio channels on the air interface are often defined by a specific radio frequency that is different than those used by other mobile phones and base stations in the area. The use of different frequency channels, often called frequency division multiple access (FDMA) enables numerous mobile stations to communicate with the same base station, for example mobile stations 102 and 103 shown in FIG. 1. Available frequencies for channelization are a limited resource, however, so the low power transmission enabled by the cellular network architecture enables frequencies to be reused in non-adjacent cells.

To enable even more mobile phone to base station communications to occur in the same cell, each frequency channel may be divided up into a number of time slots. Each time slot recurs periodically and is assigned to a specific communication channel. The time slots are of such duration and recur often enough that even a voice conversation transmitted in this way may appear uninterrupted. This type of multiple access is frequently referred to as TDMA (time division multiple access).

Yet another manner of providing for numerous separate channels in a wireless communication system is the use of spread spectrum technology. In these types of systems, individual transmissions are spread across the entire available frequency spectrum (or a selected portion of it) using a spreading code. A large number of spreading codes are normally made available for this purpose, meaning that a number of different communications may take place in the same frequency band. The target receiver will be able to recognize the spreading code used for any particular transmission, and therefore detects only those transmission intended for it and discards any others. The spreading codes used in a particular area are orthogonal to each other, thus reducing or eliminating the interference between the different channels (some interference will still occur because of non-ideal conditions and other factors).

This type of channelization is often called code division multiple access (CDMA). A variation of CDMA is referred to as wide band CDMA (WCDMA), and involves somewhat different transmission spreading process. Although the specifics of the processes for spreading transmissions in CDMA and WCDMA are not directly relevant to the present disclosure, it is worthy of note that transmissions in such systems are spread somewhat differently in the uplink from those downlink transmissions.

CDMA systems (including WCDMA systems) also rely on power control mechanisms. To further avoid interference, each communicating device (mobile phone or base station) will adjust its power level in order to use the minimal amount of transmission power necessary to transmit a reliable signal. In addition, regulatory agencies often require a limit on the aggregate power used for transmission in any given area. To reduce transmission power to a minimum, measurements of received signals are taken in order to judge the distance to another station, and as an ongoing communication session proceeds, the power level is adjusted as necessary to achieve the desired QoS. Naturally, any other way to reduce the transmission power necessary in a particular cell would also contribute to this advantage, and other methods of reducing power requirements have evolved. One particularly effective method is the use of mobile receive diversity (MRD).

In transmit and receive diversity, certain qualitative advantages have been found in using multiple antennas to transmit and multiple antennas to receive radio signals. Some applications involve sending more than one transmission using each of the available antennas. Others involve sending the same transmission over multiple antennas in order to improve the chances that the signal will be properly received. It is not necessary in all cases that the communicating transmitters and receivers each use an identical number of antennas. MRD is simply the part of this general scheme in which a mobile phone uses multiple antennas for receiving transmissions from a base station or other source. As alluded to above, this improves the transmission QoS and permits lower transmit power to be used. Mobile phones, however, present a particular challenge in the field of receive (or transmit) diversity, because the space available for additional antennas is not unlimited.

FIG. 2 is an illustration of a mobile phone 200. Its well known features will be described here only briefly. Mobile phone 200 has an externally-accessible power switch 205, which is used to turn the unit on and off. To interface with the mobile phone to place or receive a call, or to perform other operations, the user interface includes a keypad, that is a set of keys shown generally at 210. Keypad 210 includes call control keys 212 and 213, and an alphanumeric keypad 217.

Display 220 visually presents certain information for the user's benefit in operating the mobile phone. Scroll key 215 is used to manipulate objects on the display for the user's benefit, and to alter the operation of mobile phone 200 in a predetermined way. Function keys 214 and 216 operate in a similar manner, the effect of their next actuation being displayed on the display 220 so that the user will know which action is being selected. Mobile phone 200 is typically powered by a battery (not shown), but may also be connected to an external power source through power port 225.

Peripheral devices (not shown in FIG. 2) may be used with mobile phone 200, such as microphones and speakers, which are connected in this illustration through external device connector 230. Mobile phone 200 also includes these features so that it can be used without any external device. The microphone and speaker are not shown in FIG. 2, but sound reaches these internal components through microphone port 235 and speaker port 240, respectively.

The mobile phone 200 of FIG. 2 is, of course, exemplary; many types of mobile phones are in use today and others are already planned for future deployment. For this reason, it should be noted that as the terms for radio telephones, such as “cellular (or cell) phone” and “mobile phone” are often used interchangeably, they will be treated as equivalent herein. Moreover, both terms refer to a sub-group of a larger family of devices that also includes, for example, certain computers and personal digital assistants (PDAs) that are also capable of wireless radio communication in a wireless network. This larger family of devices will for convenience be referred to as “mobile phones” or “mobile stations” (regardless of whether a particular device is actually moved about in normal operation). Mobile phones may transmit voice or data, or both.

Mobile phones have recently increased in popularity for many reasons, some of which have been alluded to above. Naturally, their mobility is often an advantage, and users appreciate the ability to communicate using their own telephone regardless of their location. Initially, however, mobile phones were quite expensive and only used by those who could either afford them or absolutely needed them. Network capacity was limited and quality of service was often poor. The existing infrastructure of several years ago could certainly not have supported the level of traffic that exists today. The increased use of mobile phones, therefore, has been facilitated by advancements both in mobile phone and in network technology that have enabled many mobile phones to effectively communicate at the about same time, even in a relatively small geographic area.

In addition, modern mobile phones can perform many more functions than their predecessors. For example, many mobile phones are now capable of sending and receiving short text messages (sometimes called SMS (short message service) messages). Others can even send email messages. Currently, many networks are even permitting the sending of graphic images and other non-text information. Two mobile devices may even exchange data files that were traditionally exchanged only by hardwire connection. The Internet has for several years been used for this purpose, and many modern mobile phones may now access the Internet for this purpose and to use World Wide Web applications and send email. Naturally, the increased functionality that mobile phones now enjoy has also contributed to their popularity. Needless to say, however, with increased popularity and the number of different applications for which mobile phones can be used, mobile networks constantly need to increase their capacity. At the same time, operators must supply the higher-quality services that consumers are now demanding. Using MRD is one way to do this. Expense and the physical limitations referred to above, however, make universal application of MRD difficult.

Needed is a way to increase the capacity of wireless, and especially CDMA and W-CDMA mobile communications systems by providing an MRD option that overcomes these limitations and is likely to be commercially advantageous. The present invention provides just such a solution.

### SUMMARY OF THE INVENTION

The present invention provides a way to enable MRD in wireless communication systems without necessarily increasing the cost of basic mobile stations to the operator. To accomplish this objective, the present invention is directed to a detachable external antenna module for use with a wireless mobile station. The mobile station, which typically communicates on a radio frequency channel with a base station connected to the fixed infrastructure of a wireless communication network, may be able to receive transmission from the base station sent at lower power by applying mobile receive diversity (MRD).

In one aspect, the present invention is an antenna module including an antenna element supported by, and preferably totally enclosed in a housing, which housing may also contain radio frequency (RF) receive circuitry. The antenna module may also include other electronics as well, such as power management and authentication-related circuitry. In some embodiments, the antenna module is in a single housing and in other embodiments, more than one housing section may be used. The antenna module of the present invention is intended for use with a mobile phone, and the antenna-module receive circuitry may, in use, be coupled with the digital processor of a mobile phone via an analog-to-digital converter. The antenna module includes a jack for attaching the antenna module to a mobile phone. The jack provides for data, and preferably power links to be established with the mobile phone. Control signals may be passed through the jack as well. The jack preferably holds the antenna module in the desired orientation with respect to the mobile phone, and may permit adjustment in several directions so that the orientation of the antenna element relative to an antenna internal to a mobile phone can be adjusted.

### BRIEF DESCRIPTION OF THE DRAWINGS

For a more complete understanding of the present invention, and the advantages thereof, reference is made to the following drawings in the detailed description below:

FIG. 1 is functional block diagram illustrating the relationship of selected components of a typical CDMA telecommunication network, such as one that might advantageously employ the hybrid receiver of the present invention.

FIG. 2 is an illustration of a typical mobile telephone, such as one that may be used to communicate via a wireless network such as the one illustrated in FIG. 1.

FIG. 3 is a simplified block diagram illustrating selected components of an antenna module according to an embodiment of the present invention.

FIG. 4 is a simplified block diagram illustrating selected components of a mobile phone employing the antenna module shown in FIG. 3.

FIG. 5 is a simplified block diagram illustrating selected components of antenna module interface according to an embodiment of the present invention.

FIG. 6 is an illustration of a mobile phone with an attached antenna module according to an embodiment of the present invention.

FIG. 7 is an illustration of the antenna module shown in FIG. 6.

FIG. 8 is a simplified illustration of two antennas for use in accordance with an embodiment of the present invention.

FIG. 9 is an illustration of an adjustable antenna module according to an embodiment of the present invention.

### DETAILED DESCRIPTION

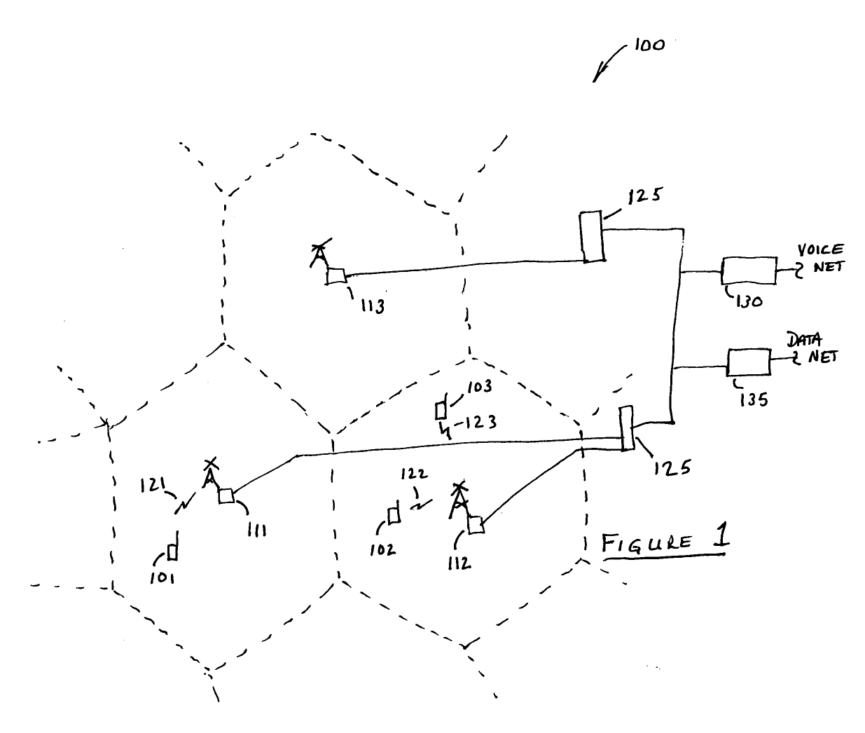

FIGS. 1 though 9, discussed herein, and the various embodiments used to describe the present invention are by way of illustration only, and should not be construed to limit the scope of the invention. Those skilled in the art will understand the principles of the present invention may be implemented in any similar radio-communication device, in addition to those specifically discussed herein.

The present invention is directed to an antenna module for using in connection with a mobile phone that may be used to provide mobile receive diversity (MRD) while at the same time overcoming many of the disadvantages accompanying prior attempts to achieve this result.

FIG. 3 is a simplified block diagram illustrating an antenna module 300 according to an embodiment of the present invention. Antenna module 300 includes an antenna element 305, which will provide diversity when used in conjunction with the internal antenna of a mobile phone (not shown in FIG. 3). Note that antenna element 305 is shown schematically in FIG. 3, and no limitation on its physical configuration is intended; antenna element 305 may be of various designs. The antenna element 305 will normally be partially or completely enclosed by a housing 310. Because complete enclosure of the antenna element (or other components of the antenna element, if present) is not required in all embodiments of the present invention, the antenna element will be said to be “supported” by the housing. The housing may be in more than one physical portion.

In the embodiment of FIG. 3, circuitry for processing the signal received at antenna element. The exact configuration of this circuitry may vary, and in FIG. 3 it is represented by the broken line denoting radio-frequency (RF) chain 315. In a preferred embodiment, RF chain 315 includes not only an RF receiving circuit 320, but an analog-to-digital (A/D) converter 325. A physical connector is present to function as a data link 330, which may be used to couple the RF chain 315 to an appropriate mobile-phone circuit for processing the received signal. Preferably, the components of RF chain 315 receive their operating power from a mobile phone via power link 335.

Note that mobile phones contain circuitry for receiving radio signals and converting them to digital form for processing, at least for their own internal antennas and perhaps for multiple or additional antennas as well. Placing the RF chain in antenna module 300, however, makes it possible to more completely isolate the antenna element 305 (from the internal antenna of the mobile phone). This helps to lower correlation between the antennas and enhances the benefit received from using antenna module 300 to achieve MRD. In an alternate embodiment, however, one or more components of RF chain 315 may be located internally to a mobile phone designed for use with an antenna module without them. In yet another embodiment, RF components may be housed in a device separate from both the mobile phone and the antenna module (instead of or in addition to those present in the antenna module itself). Other components (not shown) may also be included in antenna module 300. For example, a power management function, with appropriate circuitry may be included. Components supporting an authentication function may be present as well.

FIG. 4 is a simplified block diagram illustrating selected components of a mobile phone 400 employing the antenna module 300 shown in FIG. 3. In this embodiment, mobile phone 400 includes an antenna element 405 such as one normally found in mobile phones of the prior art. RF circuitry 420 receives radio signals, which are converted to digital form in A/D converter 425 for processing by digital signal processor (DSP) 445. (An analogous digital-to-analog (D/A) converter (not shown) may be present to convert signals from DSP 445 for transmission via RF circuitry 420 and antenna element 405.) Controller 450 controls the operation of the various components of mobile phone 400. Memory module 455 (which may include more than one physical device) is used for short- and long-term data storage. When used with antenna module 300, data link 330 is coupled with an external antenna module interface 440 that provide the received signal, if any, to DSP 445. The data link 330 is for passing data, and may be used for passing control signals as well. A separate link (not shown) for passing control signals between antenna module 300 and mobile phone 400 may also be provided. Communications between antenna module 300 and mobile phone 400 may be accomplished according to a standard communication protocol, such as for USB (universal serial bus) or Firewire (IEEE-1394) connections. Alternately, a manufacturer or vendor-specific communication protocol may be implemented, which enables the manufacturer or vendor to customize the link and perhaps to limit the use of inappropriate devices. Power link 335 is, in this embodiment, coupled with an internal or external power source associated with mobile phone 400.

DSP 445 is, of course, operable to process incoming signals received at antenna element 405. In accordance with the present invention, it is also operable to process signals received at antenna element 305 when antenna element 300 is coupled to mobile phone 400 via data link 330. Moreover, DSP 445 is operable to utilize the signals received at both of the antennas to achieve MRD. Preferably, mobile phone 400 may operate in either mode, that is, with a single antenna or applying MRD, and can switch back and forth from one mode of operation to the other when the antenna module 300 is either removed or connected. In other words, without antenna module 300, mobile phone 400 is nevertheless capable of operation within a wireless communication network. When antenna module 300 is connected to mobile phone 400, DSP 445 processes both signals applying MRD techniques and the benefits of MRD can then be realized. Note, however, that an actual performance improvement, although expected, is not a requirement of the present invention.

In one embodiment, antenna module interface 440 detects when an external antenna module such as antenna module 300 has been attached to mobile phone 400. The data link 330 may be, but is not necessarily established immediately when the external antenna is present. Where the phone is capable of switching to MRD processing even while being used, it is generally preferred that it do so as soon as antenna module 300 is detected. The creation of data link 330 may require only the physical connection of antenna module 300, or a separate switch (not shown) may intervene. In the former case, when the connection is made the signal from antenna module 300 is provided to DSP 445, MRD processing begins.

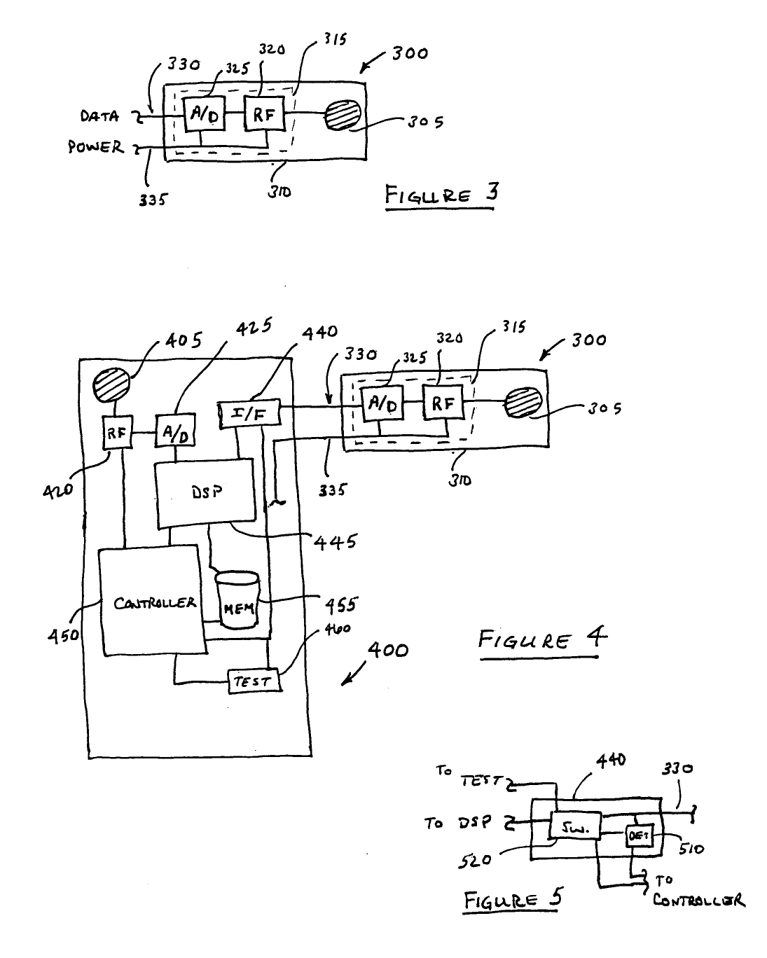

According to another embodiment of the present invention, a decision must be made to begin MRD processing. FIG. 5 is a simplified block diagram illustrating selected components of antenna module interface 440 according to one embodiment of the present invention. In the illustrated embodiment, data link 330 is coupled to DSP 445 though a switching circuit 520. The switching circuit may be controlled by controller 450 or detector 510, or both. In one embodiment, when detector 510 detects that a signal is being received from an external antenna, it notifies controller 450. When controller 450 is notified that an external antenna signal is available, it determines whether and how to make use of the signal. Where user interface is desirable, controller 450 may cause an indication that the external antenna is attached to appear on display 220, or at another indicator device such as an LED usable for such a purpose. The user may be queried as to whether the signal from the external antenna module 300 should be used. Upon receiving a positive response from the user, controller 450 then directs switch 520 to complete data link 330 to the DSP 445 (or to another desired component).

In another embodiment, controller first directs switching circuit 520 to couple the external antenna signal to a test circuit 460. Test circuit 460, though not required, provides the ability to test the incoming signal and it's impact. Testing the incoming signal may, for example confirm that the use of the additional antenna will in fact have a helpful effect on processing. If the antenna is not functioning or is not connected properly, for example, this can be discovered before the input via data link 330 is allowed to affect the signal processing. For another example, if the input from data link 330 is substantially the same as the output of A/D converter 425, then the positive effect of MRD will not be realized.

The test circuit 460 might even be used to compare the outputs of the antenna module antenna and the mobile phone internal antenna and determine which should be used in the event MRD cannot be achieved. In some embodiments, it may also be desirable to inform the user of the results of any signal testing, especially where user confirmation of any change in signal processing is being requested. If the test circuit indicates that the signal arriving from the external antenna module via data link 330 is advantageous to use, then the controller 450 directs that the data link be completed to DSP 445, perhaps after querying the user as described above. Other components may be contained in the interface 440, including for example an analog to digital converter in case one is not present in a given antenna module. Note also, however, that the detector and switch of FIG. 5 are not required unless called out in a particular embodiment.

FIG. 6 is an illustration of a mobile phone with an attached antenna module 600 according to an embodiment of the present invention. In this embodiment the antenna-module components, for example those shown in FIG. 3 (but not in FIG. 6), are enclosed in a housing 610. The housing is not required to be identical to housing 610, but is preferably sturdy enough the antenna module 600 can be easily carried in the user's pocket, purse, or briefcase without fear of damage. The antenna module 600 in FIG. 6 is disposed immediately adjacent to a side 255 of mobile phone 200. This is only one configuration, however, and many others are possible. This configuration of FIG. 6 is not necessarily preferred, but does allow the user of mobile phone 200 to grip and the assembly in much the same fashion as would be done without antenna module 600.

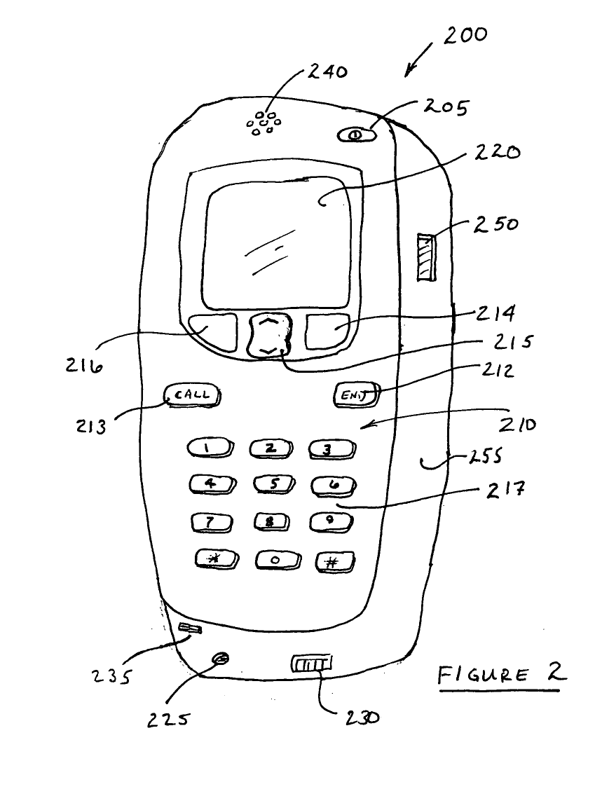

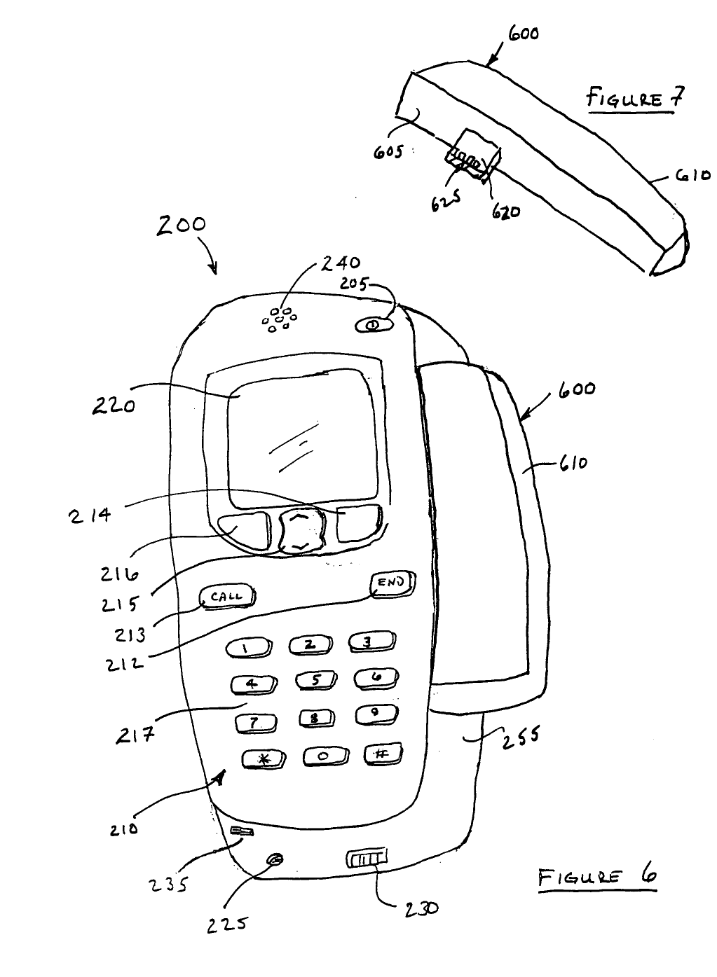

FIG. 7 is an illustration of the antenna module shown in FIG. 6. From this view it is apparent that a connection jack 620 extends outwardly from inner face 605 and includes contacts 625. In the assembled configuration shown in FIG. 6, jack 620 is received into external antenna port 250 shown in FIG. 2. Contacts 625, when so inserted, make contact with corresponding contacts (not shown) within mobile phone 200 and form parts of the data link 330 and the power link 335 (shown in FIG. 4). Note that in some embodiments, the jack is formed integrally with the antenna module housing, while in others it is separate and coupled electronically to the antenna module components via a wire or other connection.

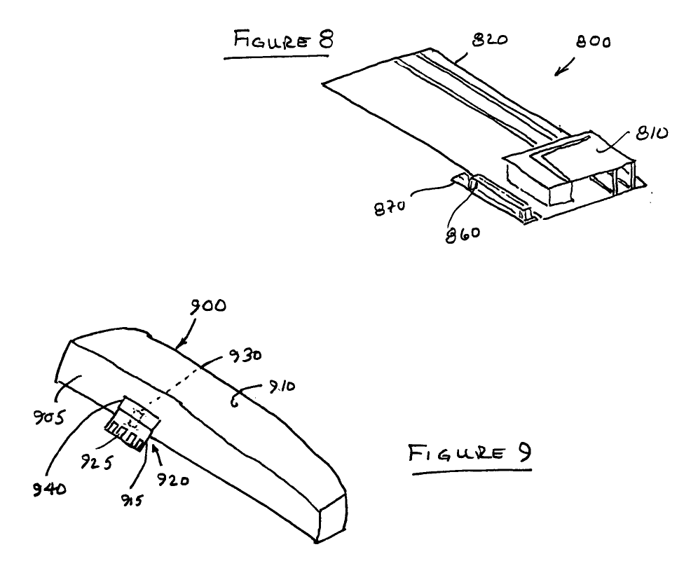

FIG. 8 illustrates the relationship of the main antenna 810 of a mobile phone and the diversity antenna 860 of an antenna module according to an embodiment of the present invention. The housings and most of the internals of each of these components of an assembly 800 are not shown for clarity. The data link and the power link are also omitted. Main antenna 810 is, for example, a dual-band planar inverted-F antenna (PIFA) mounted in a spaced apart relationship to a printed wire board 820 forming the ground plane for the main antenna 810. The diversity antenna 860 is, for example, an inverted-F antenna (IFA), having a ground plane formed of printed wire board 870. Maintaining separate ground planes for the two antennas helps to isolate them from each other and reduces any correlation effect. The relative sizes and orientation of the two antennas are exemplary and not limiting, other configurations are possible. Note also that the number of antennas is not limited to two, although any advantage from having more than two antennas contributing to MRD may be small.

Although the configuration of FIG. 6 may provide acceptable MRD and result in improved performance, other factors may affect this outcome such as antenna position relative to the signal source or to the user's body. Where the antenna module of FIG. 7, for example, simply plugs into a mobile phone, the resulting configuration may not be optimal. Some flexibility may therefore prove to be advantageous. FIG. 9 is an illustration of an adjustable antenna module 900 according to an alternate embodiment of the present invention.

Similar to the embodiment of FIG. 7, antenna module 900 includes a jack 920 extending outwardly from inner face 905 of antenna-module housing 910. When inserted into port 250 of mobile phone 200, however, external portion 940 remains outside of the housing of mobile phone 200, while internal portion 915 of jack 920 is actually received into port 250. When so installed, the external portion 940 of housing 910 is free to rotate about pin 930 with respect to internal portion 915 (and mobile phone 200). In some designs, this will result in housing 910 of antenna module 900 being disposed somewhat spaced apart from mobile phone 200 (unlike the illustration of FIG. 6). In another design, a recess (not shown) may be formed on inner surface 905 such that external portion 940 of jack 920, situated within the recess, remains outside of antenna port 250 even when inner face 905 is immediately adjacent the side 255 of mobile station 200.

From these illustrations, it should be apparent that other types of relative movement may be achieved with variation in the design of the antenna module housing and connector jack. For one example, the diversity antenna element (represented as 305 in FIGS. 3 and 860 in FIG. 8) may be moved nearer or farther away from the mobile phone internal antenna. For another example, a hinge may be provided to permit rotation about an axis different from that of pin 930 (shown in FIG. 9). An elongated recess or slot may also be provided in inner face 905 to permit antenna housing 910 to slide toward one end of the phone or the other. In other embodiments (not shown), as mentioned above, the jack may not support the antenna module in position at all, but simply from the connection point with the mobile phone. In this case other means may be included for maintaining or adjusting the orientation of the antenna module antenna element.

This flexibility in diversity antenna positioning allows the relative orientation of the multiple antennas to be adjustable. Adjustment by the user is expected, although some designs may encourage adjustment only by a technician. In any case a locking means, or at least some resistance to repositioning, may be provided so that a stable configuration is achievable. Flexibility in antenna configuration provides a way to attempt optimization of the benefits of MRP.

In one embodiment, testing circuit 460 is operable to evaluate be benefit achieved using any particular orientation. Controller 450 monitors this evaluation, and may signal the user (for example using an appropriate indication on display 220) when a relatively advantageous orientation occurs. Although it may not always be practicable for the user to continually readjust the position of the antenna mobile, in other applications there may be a benefit to doing so.

In yet another embodiment, the antenna element itself may be adjusted within the antenna module housing, either physically, electronically, or both. This internal adjustability may be controlled by controller 450 based on the evaluation performed by test circuit 460, permitting automatic adjustment. Where automatic adjustment is enabled, the user may be permitted to override any adjustments, or elect to have the automatic adjustments disabled.

When testing or evaluation of the received signal is performed, the results could also be provided to the network. In this manner, the network becomes aware which stations in its coverage area have this capability. Transmit power calculations may (or may not) take this MRD capability into account. In some applications, it may be advantageous for the network to be able to direct a mobile phone equipped with an antenna module how to use it.

While the mobile phone user benefits by using the antenna module of the present invention, the network operator will also benefit. As MRD increases the QOS for the user, it also permits the base station to transmit with less power and still achieve an acceptable quality level. This lower-power requirement reduces the total power required for communicating with a given number of mobile stations, and therefore increases the capacity of the network (where aggregate power is limited). The external, detachable antenna module of the present invention seeks to provide MRD for a mobile phone using maximum practical antenna isolation to reduce antenna correlation effects.

In addition, using the antenna module of the present invention also means that aside from an antenna module port and the capability to process signals from the additional antenna element, few changes will be required to existing mobile phones. Several options exist for allocating the cost associated with the antenna module itself. First, of course, it could simply be provided with the mobile phone itself, although manufacturers and operators may prefer to sell it as a separate accessory. In some cases, consumers may be willing to bear the cost is a perceivable increase in performance can be obtained. On the other hand, operators needing to increase capacity may simply absorb the additional cost. Some discrimination may be appropriate. An antenna module might be given (or sold) to users who frequent high traffic areas, for example, while those living and working in suburban areas may gain little from its use. Or the antenna modules might be provided for subscribers expected to use their phones a great deal, and for data-intensive applications, as opposed to subscribers who anticipate only occasional voice use.

To encourage subscribers to purchase the antenna module as a separate accessory, incentives may be provided. For example, a lower rate may be applied when the module is used, or used within a high traffic area (in which case use of the antenna module would likely have to be in some way monitored, and perhaps controlled by the system operator). In other cases, the cost may be absorbed in a lower monthly subscription price for a given period, or rebated to customers who remain subscribers for a certain length of time. In any event, offering the antenna module of the present invention makes most or all of these options available, while at the same time improving network capacity.

Note also that different antenna modules may be designed for use with the same mobile phone. In this way, the antenna module may, in addition to (or instead of) providing MRD, make available an antenna suitable for alternate forms of communication. For example, one antenna module may be well-suited for CDMA communications, while another is designed primarily for GSM networks. In another embodiment, an antenna module may include an antenna element for short range communication, such as in a Bluetooth or IEEE 802.111 system. As the number of multi-mode phones increases, being able to select from several antenna module choices might allow for optimization in a variety of environments. Even in a single mode, different antenna modules could be provided so that the best for a particular geographic location can be selected. The separate nature of the antenna module also facilitates, in some cases, the implementation of upgrades. Finally, note that there is no requirement that the antenna module of the present invention be used continuously in all situations, or always used only to provide MRD, even when attached to a mobile phone. Intermittent use, or use in lieu of the main mobile station antenna, may in some situations be desirable.

The preferred descriptions are of preferred examples for implementing the invention, and the scope of the invention should not necessarily be limited by this description. Rather, the scope of the present invention is defined by the following claims.

What is claimed is:

1. An antenna module for use with a mobile station, comprising:
an antenna element;
a radio-frequency (RF) chain;
a housing for supporting the antenna element;
a connector for removably coupling the antenna element and the RF chain to the mobile station.

2. The antenna module of claim 1, wherein the mobile station includes an installed antenna element and is operable to utilize the antenna module for mobile receive diversity (MRD).

3. The antenna module of claim 2, wherein the mobile station is also operable to utilize the antenna module for transmit diversity.

4. The antenna module of claim 1, wherein the RF chain comprises an analog to digital converter (ADC).

5. The antenna module of claim 1, wherein the connector is a universal serial bus (USB) connector.

6. The antenna module of claim 1, wherein the connector is a Firewire (IEEE-1394) connector.

7. The antenna module of claim 1, wherein the connector is operable according to a vendor-specific communication protocol.

8. The antenna module of claim 1, wherein the housing substantially encloses the RF chain and the antenna element.

9. The antenna module of claim 8, wherein the housing comprises a plurality of housing sections.

10. The antenna module of claim 9, wherein the antenna element and the RF chain are enclosed in different housing sections.

11. The antenna module of claim 1, wherein the connector provides structural support for the housing when the antenna element is coupled to the mobile station.

12. The antenna module of claim 11, wherein connector permits the antenna element to be adjustable in orientation with respect to the mobile station.

13. A mobile phone system, comprising:
a mobile phone comprising an internal antenna, wherein the mobile phone is operable using the internal antenna; and
at least one antenna module comprising an antenna element and an RF chain for processing RF signals received by the antenna element;
wherein the at least one antenna module includes a coupling for releasably attaching the module to the mobile phone; and
whereing the mobile phone is operable to implement MRD when the at least one antenna module is attached to the mobile phone.

14. The mobile phone system module of claim 13, wherein the mobile phone is operable in a wireless communication system operable to utilize a power control function.

15. The mobile phone system module of claim 14, wherein the wireless communication system is operable according to a CDMA protocol.

16. The mobile phone system module of claim 13, wherein the at least one antenna module is a plurality of antenna modules.

17. The mobile phone system module of claim 16, wherein the mobile is operable according to a plurality of communications protocols and where each module of the plurality of antenna modules is operable to create MRD when the mobile phone is operating according to at least one of the plurality of communications protocols.

18. The mobile phone system module of claim 13, wherein the antenna module is adjustable when attached to the mobile phone.

19. The mobile phone system module of claim 18, wherein antenna module is automatically adjustable.
